(19) United States
(12) Patent Application Publication
(10) Pub. No.: US 2003/0067235 A1
(43) Pub. Date: Apr. 10, 2003

(54) Diamagnetic propulsion vehicle

(76) Inventor: Arturo Acevedo Vazquez, Bayamon, PR (US)

Correspondence Address: LILLIAM E. MENDOZA TORO ESQ., 376 CESAR GONZALEZ, HATO REY, PR, 00918, US

(21) Appl. No.: 09/974,928

(22) Filed: Oct. 10, 2001

(51) Int. Cl. H02K 21/00

(52) U.S. Cl. 310/152

(57) ABSTRACT

In this vehicle, the diamagnetic fields principles are applied to obtain a hovering and propulsion effect which makes low cost, friction free and zero pollutant emissions transport media. This is done using a special combination of electromagnetic generators and the natural diamagnetic susceptibility present in all elements. The physical effect of this phenomenon is an air gap between the surface and the vehicle. The height of levitation has a direct relationship with the material used as floor surface; since all materials have different diamagnetic susceptibility factors. Also, the power on the diamagnetic field generator is a key for the levitation and propulsion effect. All these factors make this prototype vehicle an easy maneuverable one, since there are almost no inertial forces present in the system.

### INTRODUCTION

A diamagnetic force can be used to produce vehicular motion, instead of direct mechanical, hydraulic, or pneumatic force. Diamagnetic forces are formed, for example; by the induction of current through a coil or solenoid, or are already present in a permanent magnet. The application used is the diamagnetism, which is not a very common electromagnetic principle. It is well known that when a piece of iron is in presence of an electromagnetic field, an attraction effect will occur between them, this is due to the natural atomic orientation or polarization of the iron atoms. This phenomenon is better known as Ferromagnetism.

Diamagnetism can be understood as the opposite case of ferromagnetism; hence having an element that is in presence of an electromagnetic field, the atoms will repel or move away from the electromagnetic field source. Now, applying this concept to a vehicular system, a reliable levitation transport media results. Using a cost efficient diamagnetic element as “running” surface and specially designed electromagnetic generators a vehicle can levitate form the ground and move with almost no friction. The whole concept is to have a special composite surface to run the vehicle instead of regular asphalt roads. This transport media runs on electricity, which could be obtained from the sun, solar cells and high efficiency batteries. The experimental top speed of the system is 560 km/hr or 348 mi/hr; these results were obtained from previous experiments done with similar electromagnetic transport devices, such as Germany's Maglev Transrapid train. The vehicle's safe running speed is 144 km/hr or 90 mph. The system maintenance is non-complex due to the simplicity and small quantity of parts. The height of levitation for this scale prototype is 11 cm and the max load supported is 1.5 times the vehicles weight, it uses 15 amps AC and 120V. There is no need of lubricants or oil in the system, since there are no rolling parts or internal combustion engine.

### BACKGROUND

For many years we have had transportation vehicles which are less efficient in relation with the energy it uses. The majority of the energy is lost between friction and heat. These machines only use from 15%-30% of consumed energy. Another problem related to the current transportation media suffer is their unavailability to operate on all kinds of surface pr environment. For each surface, utility or environment a different type of design is needed.

Various types of systems have been provided with the purpose of effecting high velocity movement of fluids and for driving vehicles on land, water, and air. Among these systems are propellers such as employed on ships and aircrafts and also reaction devices such as jets and rockets.

While propulsion system for rockets and other short range space vehicle have customarily employed chemical propellants, either liquid or solid, to provide the desired acceleration force for the vehicle, it is recognized that the performance of these chemical propellant is limited and for long term or extreme distance trips need better propulsion systems are required.

This invention relates to a method of controlling gravitation and for deriving power; and to a method of producing linear force motion. Any vehicle accelerated to an axis rotation relative to its attractive inertial mass immediately becomes activated by free space energy and acts as independent force. This is a relative velocity craft and the minute it reaches the relative velocity of the attractive inertial mass that becomes weightless as with regards this inertial attraction. Individually it is not weightless, it has the same weight as before, but when it reaches the relative location it becomes as independent system just as a planet is an independent system. It is like traveling on a small planet. The craft rotates until it reaches a high speed and raises from the ground.

We know we have at least two vortices interacting apex to apex to generate and hold mass in the microscopic or macroscopic dimensions. These vortices also disassemble mass to turn it back into the original space fabric.

Every mass has a certain field and frequency of motion that keeps it solid. Expose it to a higher frequency of rotation and it breaks bonds and changes shape, volume, pressure, density, rotation, etc. Its physical existence (third dimension existence) or manifestation is only if those conditions are met, otherwise it dissolves. Vortices, cones of energy movement, are the producers and destroyers of all these conditions for physical appearance. To understand how to produce these shapes of whirling power and alter them is the secret to manifesting and dissipating all elements and materials in this universe.

A physical object takes on and holds field shapes or geometrical pattern which are the records of what these vortices did to this object to manifest and lock it in its shape. These fields tell the angles and frequency of interaction that occurred between electricity and magnetism to produce the phenomena.

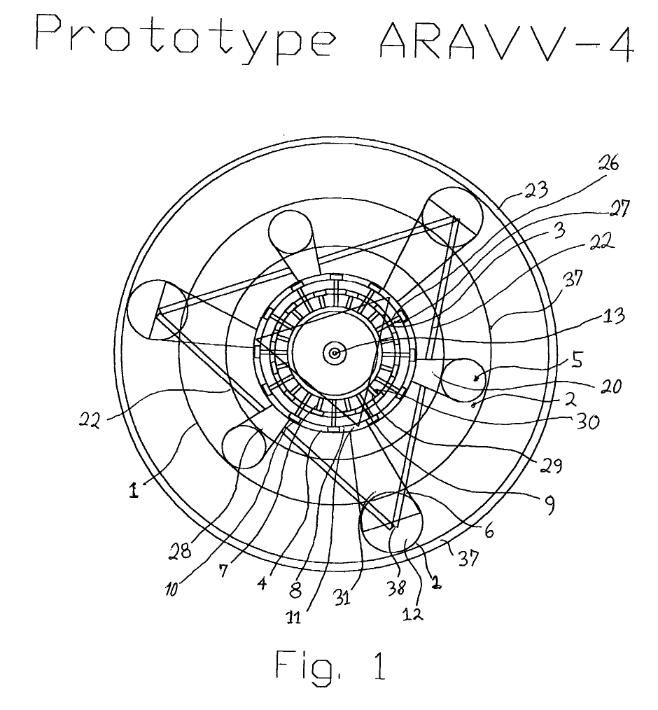

FIG. 1 Top view of the diamagnetic rotor; structure and important mechanism. Prototype ARAVV-4.

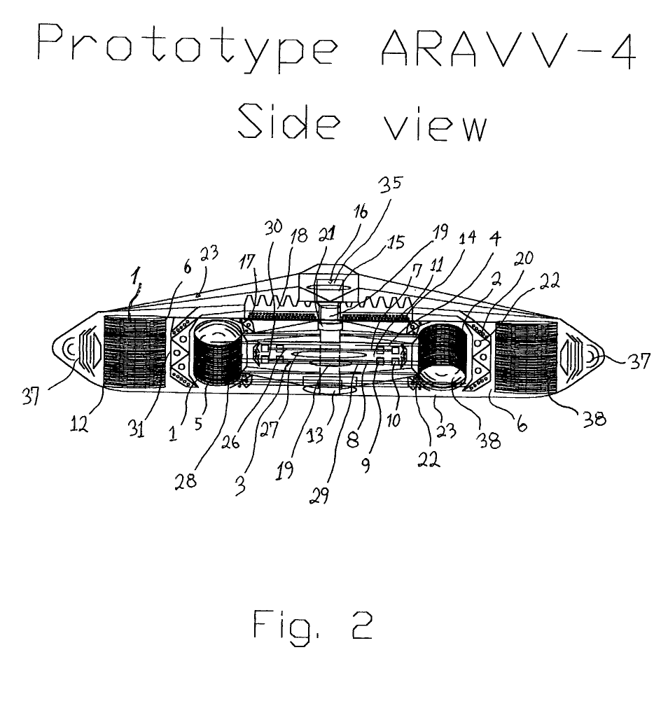

FIG. 2 Side view of the diamagnetic rotor, structure and important mechanism. Prototype ARAVV-4.

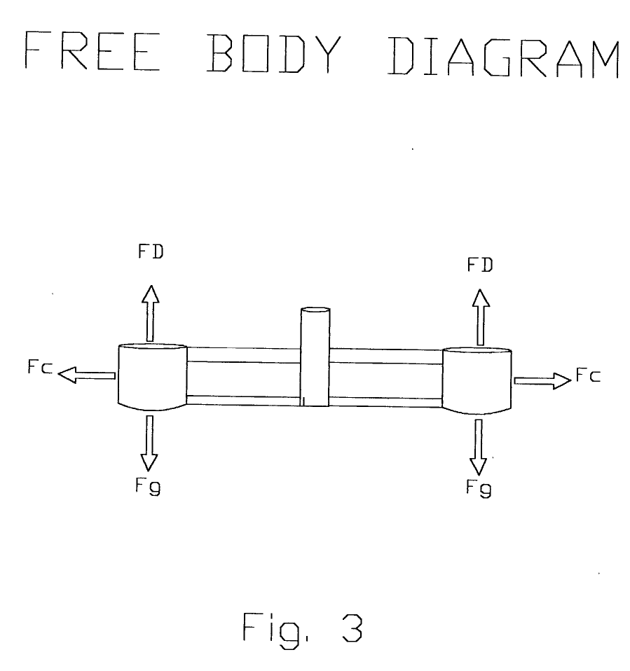

FIG. 3 Free body diagram, side view of the central principal rotor. Prototype ARAVV-3.

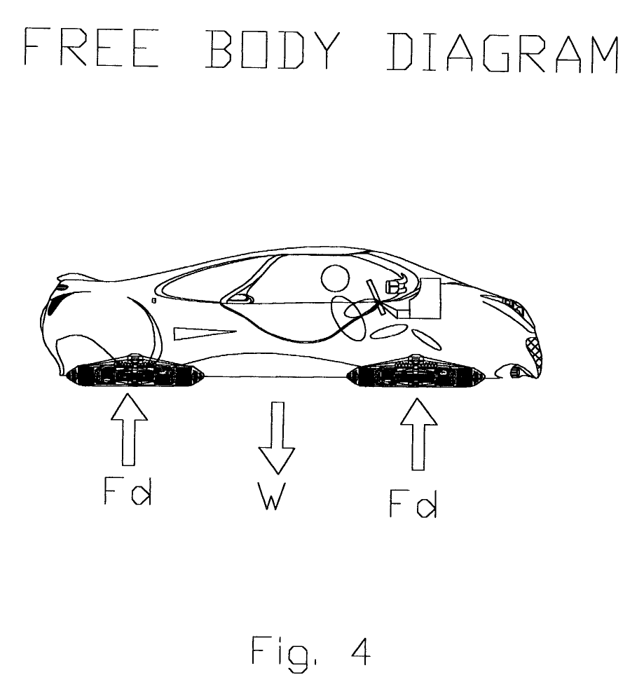

FIG. 4 Side view of a vehicle for transportation by diamagnetic propulsion. Free body diagram. Prototype ARAVV-2.

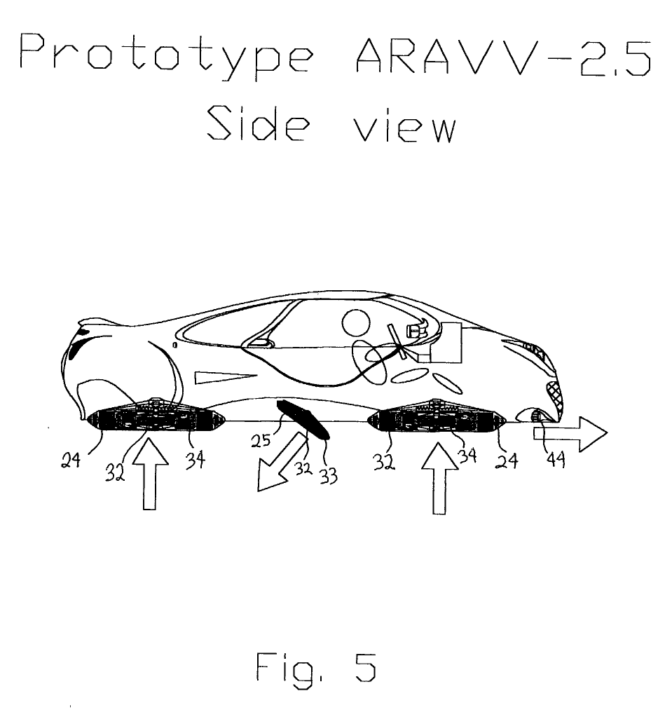

FIG. 5 Side view of the prototype ARAVV-2. Free body diagram.

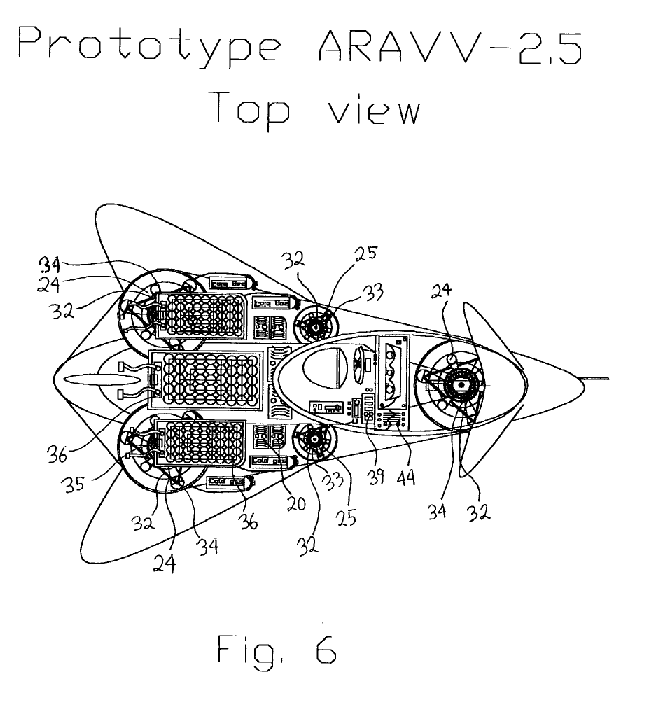

FIG. 6 Top view, vehicle components, Prototype ARAV-2.5

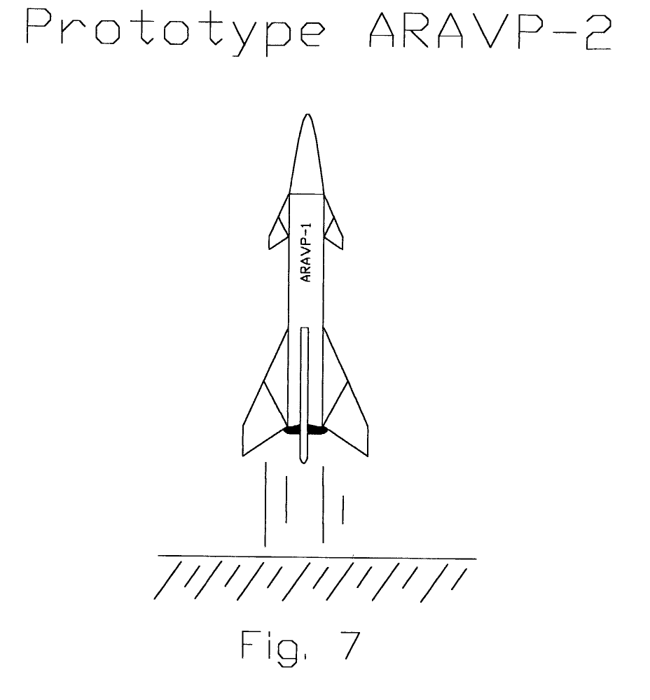

FIG. 7 Side view of a diamagnetic projectile, like missile, rocket, spacecraft and others. Prototype ARAVP-2

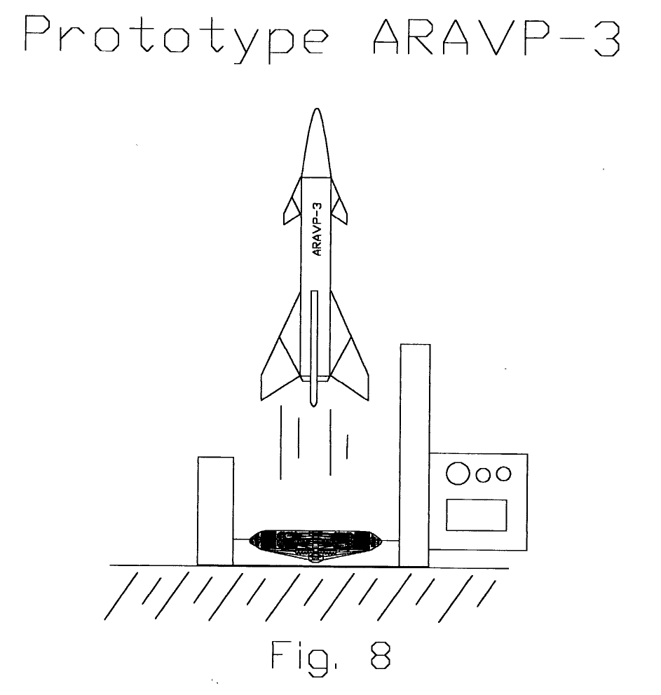

FIG. 8 Side view of diamagnetic cannon for any kind of projectile, like missile, rocket, spacecraft and others.

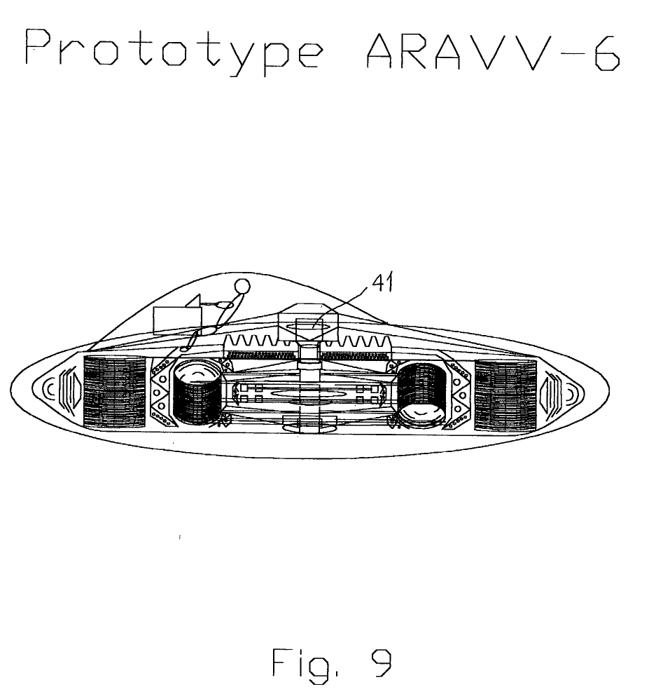

FIG. 9 Side view, vehicle with one rotor. Prototype ARAVV-6.

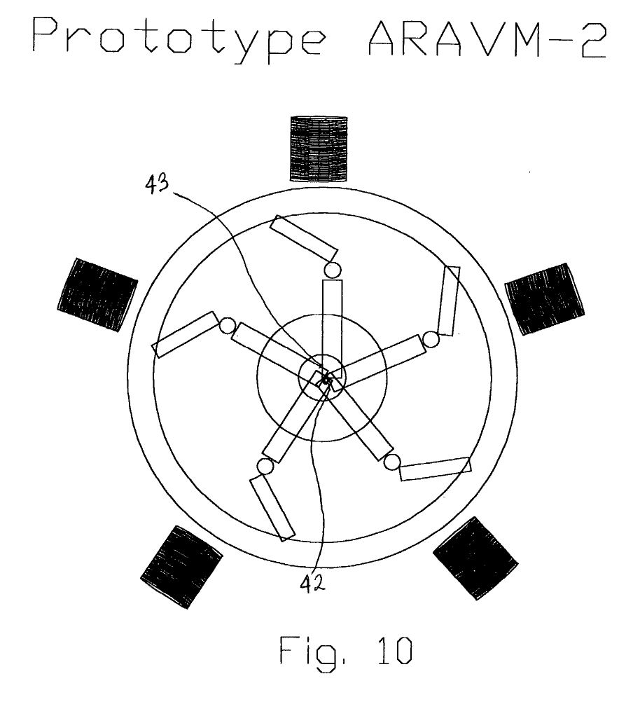

FIG. 10 Top view, motor that produces mechanical power in an axis that rotates. Prototype ARAVM-2.

### IMPORTANT SYSTEMS

1. The system of rotors consists on one or more rotors. Each rotor is composed of a system of arms with synchronization of angular rotation (natural magnets in the end of the arms) with a rotation limit of 90 degrees to each side, next to one or more diamagnetic generators which rotate 90 degree each side. Arms with synchronization of rotation angular and diamagnetic generators will be distributed in a geometric position which will be balance. Each rotor rotates contrary to the rotor next to it, to obtain the relative speed.

2. System of energy composed of: A—batteries of high efficiency in energy storage, adapted inside and outside of the system. Able of being recharged by external electric sources, internal electric sources, by the rotation of each rotor and conversion of energy of heat, wind, sunlight, vibrations or another phenomenon in the atmosphere in electric power. B-Solar cells, placed in the superior part of the vehicle, depending on their geometric configuration. C-Van Graff system able to generate high electrostatic potential D-High efficiency capacitors.

### Systems

Referring to the FIG. 1 and FIG. 2 have the top view of the prototype ARAVV-4 where I present the system of rotors the following legend applies: (1). The system of rotors consists on two rotors, a primary rotor and a secondary rotor. The primary rotor (2) consists on a system of many arms with synchronization of angular rotation (3) that depending on their angular orientation, position and magnetic capacity helped to begin the movement of the mechanism. The arms (26) are composed from several connected cylinders (27) to a gear ring to rotate with synchronized, in the other end we have a natural magnet (9) which rotates 90 degrees for a side and 90 degrees for the other side. When rotating the natural magnet, being repelled of some rings (4) mounted in the rotor base, helps to begin the second phase of the primary rotor. When the first phase arrives to the required speed, the second phase is activated. The second phase wraps a system of diamagnetic generators (5) guided in a geometric form in which can balance the mechanism. These connected generators to a motor (28) can rotate in their base 90 degrees for a side and 90 degrees for the other side. The second phase generates the maximum speed of the primary rotor.

The secondary rotor (6) consists on a system of many arms with synchronization of angular rotation (7) that depending on their angular orientation, position and magnetic capacity helped to begin the movement of the mechanism. The arms (30) are composed from several connected cylinders (29) to a gear ring to rotate with synchronized, in the other end we have a natural magnets (10) which will rotate 90 degrees for a side and 90 degrees for the other side. When rotating the natural magnet, being repelled of some rings (11) mounted in the rotor base, helps begin the second phase of the primary rotor. When the first phase arrives to the required speed, the second phase is activated. The second phase wraps a system of diamagnetic generators (12) guided in a geometric form in which can balance the mechanism. These connected generators to a motor (31) rotate in their base 90 degrees for a side and 90 degrees for the other side. The second phase generates the maximum speed of the primary rotor. This secondary rotor rotates in the opposite direction to the primary rotor.

FIG. 3 and FIG. 4. Free body diagrams. Fd-Diamagnetic force, Fg-Gravity force, Fc-Centrifuge force, W-weight.

The generators consist on a solenoid. The caliber and the material of the cable for the solenoid depend on the use and the size where it will be applied. The relationship of the diamangnetism and construction of the solenoid is quadratic. These diamagnetic generators have enough force to get up more of their weight. The levitation height depends on the material that the floor is made of FIG. 5 and FIG. 6. The generator is mounted in a rotor or such as independent mechanism. The generators (32) can be mounted in any vehicle of transport to move it. The vehicle can have one or more levitation generators (34). The vehicle can also have one or more directional generators (33). Everything depends on the utility of the vehicle to be able to design the configuration of the number of generators. All the energy system is the same as the rotor system.

The primary and secondary rotors are connected to several bearings (19), to rotate around a cylindrical axis (13) which remain static next to the base of the rotor. The rotor is placed in the superior end connected to a transmission of gear (14) which will facilitate the rotation of the primary and secondary rotor. Next to the transmission we have a Van Graff system (15) and a generator of current (16).

The system of energy feeding is very complex. It consists on batteries of high efficiency (17) in energy storage, centrifuge batteries (18) that are loaded automatically when they are subjected to quick rotations, solar cells in the surface of the vehicle (36), Van Graff system (35). The batteries of high efficiency should store enough energy so that the mechanism of the rotor can work its maximum in time, without being recharged. These batteries provide energy for the diamagnetic generators, they will be connected to the capacitors (20). The centrifuge batteries take advantage of the rotation of the primary and secondary rotors. Each rotor will have its own centrifuge batteries, in the superior part of the gyrational structure of the mechanism. These will give the energy to the diamagnetic generators and the capacitors (20). This way we can use more percentage of the energy induced to the generators. The solar cells are placed depending of the type of use given to the rotor. These cells will be divided in several uses. A group will feed the battery of high main efficiency, another group goes to feed the emergency battery and another group will feed the diamagnetic generators. Van Graff system will generate the high voltages absorbed by the environment, generators, and all energy type that is surround, to transform it into electric energy to feed the batteries and diamagnetic generators. The system of rotors and the system of batteries will be connected by a system of transmission of brushes (21) inside a sealed camera. Inside the camera we will have a metallic compound, liquid compound, gaseous compound or a compound with a very high electric coefficient to have a better current flow during the electric transmission.

The chassis is composed of several structures in alloys of aluminum, carbon-fiber, keblar and compounds of resistant plastics. Each rotor has its own chassis (22) which has a bearing connected to the axis. These chassis are designed to absorb vibrations, high speeds, impact, to be lighter and to support the generators and other components of the mechanism rigidly. The chassis of the base (23) is welded to the axis of the rotor.

The cooling system is simple. Taking advantage of the rotation of the rotors, the same movement makes that the wind collides with the surface of the diamagnetic generators lowering its temperature. The cooling of the generators is very important because according to Law of the Energy Conservation, the electric power induced to the generator to transform it into a diamagnetic field which gets lost in heat. When reducing the loss of heat we will be able to have more energy for the diamagnetic field. The surface of the rotor has some small fins (37) which receive are the flow of cold air, helping to lower the temperature. Inside the rotor it has some sensors of temperature (38) which transmit the signal to a temperature control (39) the one which is connected to some tanks of cold gas (40). When the temperature passes the established limit, this sensor sends the sign to the controller, the controller opens the valve of cold gas and the cold gas falls in the generators.

In FIG. 5 and FIG. 6 I introduced five rotors. Three of the rotor of antigravity (24) lift the vehicle and two rotors work as directional systems (25). The propulsion system and brakes are the same, alone, it is necessary to rotate the directional rotors with orientation to the front for acceleration and to rotate the generators in the opposite direction to reduce velocity, stop and reverse. To make a turn to either side a directional rotor moves to the desired direction and the other rotor will remain still or will rotate just a little. The turning system seems like the one war tanks use, The vehicle can have one or more rotors for levitation. The vehicle can also have one or more directional rotors. Everything depends on the use of the vehicle to be able to design the configuration and the amount of rotors

FIG. 9. In the case of a vehicle with only one diamagnetic rotor, a directional rotor would not be needed, because a gyro is added (41) like the ones helicopter have. In the case of a train, it would only have two levitation rotors and a directional rotor, in each wagon. Compared to the systems of mass levitation that exist in Germany and Japan; this system is more economic and efficient. In aquatic systems as boats and ships, the configuration and quantities of vary depending upon their use.

FIG. 7 and FIG. 8. In the use of projectiles and projectile cannons, we will use the wanted quantity of rotors. Everything depends on the distance and the weight of the projectile. In this case only the rotor has to be connected to a great capacitor, and apply an extremely big load of electricity so that the reaction of the projectile is big and it can be shot. This projectile system is more efficient that the projectile of fuel or explosive. A projectile of fuel generates an explosion and a big noise when it goes in trajectory, it weighs a lot and they are easy to detect. My design is lighter since it doesn't have to load using a big quantity of fuel. Thus the missile has more space available for cargo or shipment. My design will travel an invisible trajectory during the night given that it doesn't produce a fire tail and no noise is produce because it does not burn fuel.

FIG. 10 It is a motor that produces mechanical power in an axis that rotates by diamagnetic generators or rotors. A motor with rotors uses the same rotor but the only difference is to lengthen the axis (42) and weld the axis to the intern rotors (43), then take out the energy of this axis. A motor with diamagnetic generators has an axis with several arms. In the end of each arm there is a plate or piece of material with a high diamagnetic coefficient. The plate or the materials are connected to a motor, to guide it in the angle desired. The purpose of this angle is to control the acceleration and direction. Around the axis with fins, there is one or more diamagnetic generators in a geometric position. With the field it can repel the plates or materials and then rotate. This system can be replaced for magnets.

Another of the systems included in the vehicle is a frequency sensor (44) with a radar that can reach as minimum sixty feet. This will enable it to measure the frequency of the next materials that compound the surface. Using this radar, the system already advances the frequency of the floor and thus has a stable trip.

The concept of the transportation vehicle is the same as the transportation vehicles used today. The only change is in the motor. The system of security, managing, lights, etc is the same. My vehicle is safer because we only depend on the wind friction. As we only depend on the wind friction my aerodynamic design changes to that of the conventional vehicle. It has some small fins and spoilers to diminish the turbulence.

I claim:

1. The invention of transportation vehicles using diamagnetic propulsion such as cars, trains, boats, air planes, space crafts, motorcycles, trucks, toys, tools and weapons which have one or more diamagnetic rotors and one or more directional rotors; or in case of diamagnetic generator, will have one or more diamagnetic generators and one or more directional generators that makes them levitate from the surface. (Apply Important Systems)

2. The invention of a projectile system and projectile cannons that use diamagnetic propulsion. It will have a base with one or more generators of rotors or one or more diamagnetic generator systems. Less energy will be applied for a short lapse of time. (Apply Important Systems)

3. The invention of toys and/or entertainment goods, such as: control remote vehicles, guns, airplanes, boats, trains, pendulum, decorations, tools, etc., that move using the diamagnetic propulsion. (Apply Important Systems)

4. The invention of a motor that produces mechanical power in an axis that rotates by diamagnetic generators or rotors.(Apply Important Systems)
